(19) United States
(12) Patent Application Publication
(10) Pub. No.: US 2021/0239351 A1
(43) Pub. Date: Aug. 5, 2021

(54) PORTABLE AIR CONDITIONER AND COOLING METHOD USING SAME

(71) Applicants: Xiaoqing ZHANG, Zhongshan (CN); Jianlang FAN, Shanwei (CN)

(72) Inventors: Xiaoqing ZHANG, Zhongshan (CN); Jianlang FAN, Shanwei (CN)

(21) Appl. No.: 17/239,595

(22) Filed: Apr. 24, 2021

Related U.S. Application Data
(63) Continuation of application No. PCT/CN2019/076238, filed on Feb. 27, 2019.

(30) Foreign Application Priority Data
Jan. 14, 2019 (CN) 201910031937.8

(51) Int. Cl. F24F 11/80

(52) U.S. Cl. CPC F24F 11/80

(57) ABSTRACT

A portable air conditioner includes a housing and a cooling system. The cooling system includes a compressor, an air outlet of which is provided with heat dissipation material; a condenser; a first fan arranged on one side of the condenser and the compressor; a throttling device; an evaporator connected to the throttling device and the air inlet of the compressor, where a solenoid valve is connected between the first evaporator and the condenser; a second evaporator connected to the throttling device and the air inlet of the compressor; a regenerator having a storage space provided with a cool storage material; a third evaporator arranged on one side of the first evaporator; a power device communicatively connected to the storage space and the third evaporator; and a second fan arranged on one side of the first evaporator and the third evaporator.

### CROSS-REFERENCE TO RELATED APPLICATIONS

This application is a continuation of International Patent Application No. PCT/CN2019/076238 with a filling date of Feb. 27, 2019, which claims the benefit of priority from Chinese Patent Application No. 201910031937.8 with a filing date of Jan. 14, 2019. The content of the aforementioned applications, including any intervening amendments thereto, is incorporated herein by reference.

### TECHNICAL FIELD

The present application relates to air conditioners, and more particularly to a portable air conditioner and a cooling method using the same.

### BACKGROUND

portable air conditioners refer to air conditioners that can be freely moved. The existing portable air conditioner includes a housing, and a compressor, a condenser, an evaporator and a heat exhaust pipe arranged in the housing, where the heat exhaust pipe extends from an inside of the housing to the outside. During the operation, the condenser and the compressor will release a large amount of heat, and the heat exhaust pipe is configured to discharge the heat generated by the condenser and compressor to the outside. However, the provision of the heat exhaust pipe will lead to a large space occupation, and also affect the appearance. In practical use, if the portable air conditioner is moved, it is also required to re-communicate an air outlet of the heat exhaust pipe with the outside each time, which is very inconvenient to use.

Therefore, it is necessary to design an improved portable air conditioner and a cooling method using the same, to solve the shortcomings of the existing technology.

### SUMMARY

An object of this application is to provide a portable air conditioner and a cooling method using the same to overcome the defects in the prior art. In the portable air conditioner of the disclosure, there is no heat exhaust pipe extending from the housing to the outside, thereby reducing the space occupation and simplifying the operation.

The technical solutions of the disclosure are described as follows.

In a first aspect, the present disclosure provides a portable air conditioner, comprising:

a housing; and

a cooling system arranged in the housing;

wherein the cooling system comprises:

a compressor;

a condenser;

a first fan;

a throttling device;

a first evaporator;

a second evaporator;

a regenerator;

a third evaporator;

a power device; and

a second fan;

wherein the compressor comprises an air inlet and an air outlet, and the air outlet is provided with a heat dissipation material; the condenser is connected to the air outlet of the compressor through a delivery pipe; the first fan is arranged on one side of the condenser and the compressor; the throttling device is connected to the condenser; the first evaporator is connected to the throttling device, and is connected to the air inlet of the compressor; a first solenoid valve is connected between the first evaporator and the condenser; the second evaporator is connected to the throttling device, and also connected to the air inlet of the compressor; the regenerator is provided with a storage chamber; a cool storage material is provided in the storage chamber; the second evaporator is arranged in the storage chamber and is in contact with the cool storage material; the third evaporator is arranged on one side of the first evaporator; the power device is communicatively connected to the storage chamber; the third evaporator is communicatively connected to the power device, and is also communicatively connected to the storage chamber; and arranged on one side of the first evaporator and the third evaporator.

In some embodiments, the regenerator is an insulated cabinet.

In some embodiments, the cooling system further comprises a first temperature detection device for detecting a temperature of the cool storage material, and the temperature detection device is communicatively connected to the first solenoid valve.

In some embodiments, the temperature detection device is communicatively connected to the compressor.

In some embodiments, the cooling system further comprises a second temperature detection device for detecting an indoor temperature, and the second temperature detection device is communicatively connected to the power device.

In some embodiments, the second temperature detection device is communicatively connected to the first solenoid valve.

In some embodiments, the housing comprises a first accommodating space, a second accommodating space and a third accommodating space that are separately arranged; the compressor and the condenser are arranged in the first accommodating space; the second evaporator and the regenerator are arranged in the second accommodating space; the first evaporator and the third evaporator are arranged in the third accommodating space; the first accommodating space is provided with a first wall; the third accommodating space is provided with a second wall; the first fan is arranged on the first wall; the second fan is arranged on the second wall; the first wall and the second wall are respectively provided on different inner side walls of the housing, so that a blowing direction of the first fan is opposite to a blowing direction of the second fan.

In some embodiments, the second accommodating space comprises a first chamber and at least one second chamber that are separately arranged; the second evaporator and the regenerator are arranged in the first chamber; the cooling system further comprises a fourth evaporator; the fourth evaporator is arranged in the second chamber; and the fourth evaporator is connected to the throttling device and the air inlet of the compressor.

In some embodiments, the heat dissipation material is aluminum substrate.

In a second aspect, the present disclosure provides a cooling method using the above portable air conditioner, comprising:

S1) placing the cool storage material in the regenerator in advance;

S2) switching on the first solenoid valve;

S3) circulating a refrigerant in the second evaporator to cool the cool storage material; and

S4) according to a temperature of the cool storage material or an indoor temperature, performing a cooling by one of mode 1, mode 2 or mode 3; wherein the mode 1 is performed through steps of:

keeping the first solenoid valve off; turning on the power device; and circularly evaporating the cool storage material in the third evaporator to cool an indoor environment;

The mode 2 is performed through steps of:

keeping the first solenoid valve on; turning off the power device; and circularly evaporating a second refrigerant in the first evaporator to cool the indoor environment; and

the mode 3 is performed through steps of:

switching on the first solenoid valve; turning on the power device; and circularly evaporating the cool storage material in the third evaporator, and circularly evaporating the second refrigerant in the first evaporator at the same time to cool the indoor environment.

Compared to the prior art, the present disclosure has the following beneficial effects.

(1) By arranging a regenerator, when the air conditioner is not in use or during a low electricity consumption period, the refrigerant is circularly evaporated in the second evaporator to cool the cool storage material, thereby storing the energy in advance. When the air conditioner is in use or during a peak electricity consumption period, the cool storage material can be circularly evaporated in the third evaporator to cool the outside alone, so that it is not required to start the compressor and the condenser for cooling, avoiding the heat discharge and reducing the electricity consumption during the peak electricity consumption period.

(2) When the first evaporator is started, the compressor, the delivery pipe and the condenser will discharge a large amount of heat to the outside. In view of this, two methods are provided herein for comprehensive heat discharge. In the first method, a first fan is arranged on one side of the condenser and the compressor, which can not only accelerate the condensation, but also promote the dissipation of the heat generated by the condenser and the compressor. In the second method, a heat dissipation material is arranged at the air outlet of the compressor, to absorb and dissipate the heat, which can dissipate the heat of the refrigerant compressed by the compressor, thereby reducing the temperature of the refrigerant and further reducing the heat emitted by the condenser to the outside. As a result, the present disclosure can greatly reduce the heat discharged to the outside, and there is no need to provide a heat exhaust pipe which is commonly configured to extend from the housing to the outside in the prior art, allowing for reduced space occupation, improved appearance and simplified operation.

(3) A first solenoid valve is provided between the first evaporator and the condenser. When the first solenoid valve is switched on, the first evaporator is communicatively connected to the condenser. When the first solenoid valve is closed, the first evaporator is not communicatively connected to the condenser. According to the temperature of the cool storage material or the indoor temperature, there are three cooling modes. In the first mode, the first solenoid valve is kept off, and the power device is turned on. In this case, the cool storage material is circularly evaporated in the third evaporator to cool the indoor environment. In the second mode, the first solenoid valve is kept on, and the power device is turned off. In this case, the refrigerant is circularly evaporated in the first evaporator to cool the indoor environment. In the third mode, the first solenoid valve is kept on, and the power device is turned on. In this case, the cool storage material is circularly evaporated in the third evaporator, and the refrigerant is circularly evaporated in the first evaporator at the same time, to jointly cool the indoor environment. In this way, an appropriate cooling mode can be selected according to the actual requirements. When the cool storage material and the refrigerant are together used for cooling, the portable air conditioner has an enhanced cooling performance together with a desirable dehumidification effect.

### BRIEF DESCRIPTION OF THE DRAWINGS

FIG. 1 is a schematic diagram of a basic structure of a portable air conditioner according to an embodiment of the present disclosure.

FIG. 2 is a schematic diagram of a partial structure of the portable air conditioner according to an embodiment of the present disclosure.

In the drawings: 1, compressor; 2, condenser; 3, first fan; 4, throttling device; 5, first evaporator; 6, second evaporator; 61, inlet; 7, regenerator; 8, third evaporator; 9, power device; 10, second fan; 11, first solenoid valve; 12, second solenoid valve; 13, delivery pipe; 14, first temperature detection device; 15, fourth evaporator; 16, cool storage material; 17, third fan; 18, second temperature detection device; 100, housing; 110, first accommodating space; 111, first wall; 120, second accommodating space; 121, first chamber; 122, second chamber; 130, third accommodating space; 131, second wall; 200, cooling system; 300, air inlet; 400, air outlet; 410, heat dissipation material; and 500, storage space.

### DETAILED DESCRIPTION OF EMBODIMENTS

In order to better understanding the object, structures, features, and effects of the present disclosure, the present disclosure will be further described below with reference to the accompanying drawings and embodiments.

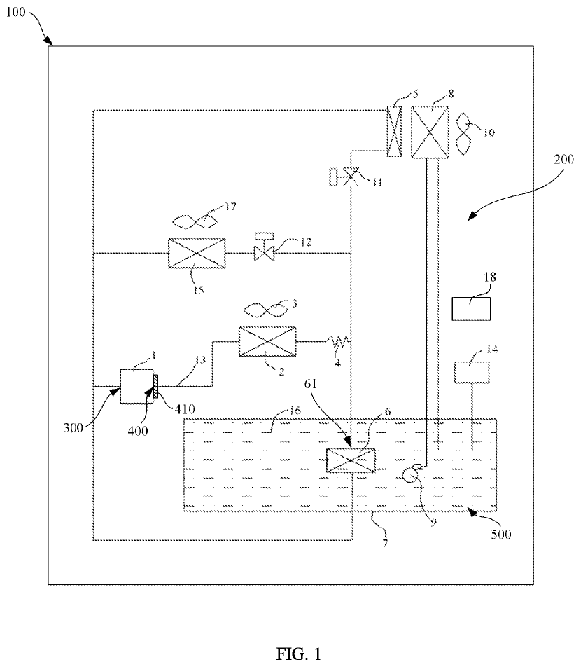

As shown in FIG. 1, an embodiment of the present disclosure provides a portable air conditioner, including a housing 100 and a cooling system 200 arranged in the housing 100. The cooling system 200 includes a compressor 1, a condenser 2, a first fan 3, a throttling device 4, a first evaporator 5, a second evaporator 6, a regenerator 7, a third evaporator 8, a power device 9 and a second fan 10.

The compressor 1 is provided for compressing the refrigerant, where the refrigerant is compressed from a low-temperature and low-pressure gaseous refrigerant into a high-temperature and high-pressure gaseous refrigerant. The compressor 1 has an air inlet 300 and an air outlet 400. The low-temperature and low-pressure gaseous refrigerant enters the compressor 1 from the air inlet 300, and is compressed into a high-temperature and high-pressure gaseous refrigerant, and then goes out from the air outlet 400. The air outlet 400 of the compressor 1 is provided with a heat dissipation material 410, which can dissipate the heat of the high-temperature refrigerant, thereby reducing the temperature of the refrigerant. In addition, since the temperature at the air outlet 400 of the compressor 1 is relatively high, the heat dissipation material 410 is provided at the air outlet 400 to dissipate heat more effectively. The heat dissipation material 410 is preferably a material with excellent heat dissipation effect. When the refrigerant passes through the heat dissipation material, the heat dissipation material 410 can dissipate most of the heat of the refrigerant.

In some embodiments, the heat dissipation material 410 is aluminum substrate, which has a good heat dissipation performance.

The condenser 2 is provided for condensing the refrigerant compressed by the compressor 1 and radiated by the heat dissipation material 410. The condenser 2 is connected to the air outlet 400 of the compressor 1 through a conveying pipe 13, where the conveying pipe 13 may be a copper pipe.

The first fan 3 is arranged on a side of the condenser 2 and the compressor 1. The first fan 3 can blow the condenser 2 to speed up the condensation of the refrigerant by the condenser 2, and speed up the dissipation of heat generated by the condenser 2 and the compressor 1 during operation.

Further, since the air outlet 400 of the compressor 1 is provided with a heat dissipation material 410 to dissipate the refrigerant compressed by the compressor 1, the heat released by the condenser 2 is greatly reduced when the refrigerant passes through the condenser 2. Therefore, the first fan 3 can be configured as a micro fan to dissipate heat from the condenser 2 with breeze, to reduce the heat radiated to the outside.

By arranging the first fan 3 and the heat dissipation material 410, the present disclosure can eliminate the heat exhaust pipe extending from the housing 100 in the prior art, which not only reduces the space occupied by the portable air conditioner, but also makes the portable air conditioner beautiful in appearance, and convenient for users to operate.

The throttling device 4 is connected to the condenser 2. The throttling device 4 can throttle to reduce the pressure and temperature of the high-pressure and normal-temperature liquid refrigerant produced after being condensed by the condenser 2, to form a low-temperature and low-pressure liquid refrigerant. The throttling device 4 may be a capillary tube.

The first evaporator 5 is connected to the throttling device 4, and the first evaporator 5 is also connected to the air inlet 300 of the compressor 1. A first solenoid valve 11 is provided between the first evaporator 5 and the condenser 2. When the first solenoid valve 11 is switched on, the first evaporator 5 is connected to the condenser 2. When the first solenoid valve 11 is switched off, the first evaporator 5 is not connected to the condenser 2.

The second evaporator 6 is connected to the throttling device 4, and the second evaporator 6 is also connected to the air inlet 300 of the compressor 1. In an embodiment, there is no control valve provided between the second evaporator 6 and the condenser 2, so the refrigerant after undergoing pressure reduction and temperature reduction in the throttling device 4 can continuously enter the second evaporator 6 for cyclic evaporation. In some embodiments, a control valve is provided between the second evaporator 6 and the condenser 2.

The regenerator 7 has a storage space 500, in which a cool storage material 16 is provided. The second evaporator 6 is provided in the regenerator 7 and is in contact with the cool storage material 16. In an embodiment, the regenerator 7 is an insulated cabinet to keep the temperature of the cool storage material 16 constant. The cool storage material 16 may be water. The refrigerant continuously absorbs heat in the circular evaporation in the second evaporator 6, thereby reducing the temperature of the cool storage material 16.

The third evaporator 8 is provided on one side of the first evaporator 5. The third evaporator 8 may be a wire tube evaporator or a thin film evaporator.

The power device 9 is communicatively connected to the storage space 500. The third evaporator 8 is communicatively connected to the power device 9, and the third evaporator 8 is also communicatively connected to the storage space 500. The power device 9 can send the cool storage material 16 in the storage space 500 to the third evaporator 8 for cyclic evaporation, that is, the cool storage material 16 returns to the storage space 500 after heat exchange in the third evaporator 8 and continues to circulate. The power device 9 may be a pump.

The low-temperature and low-pressure liquid refrigerant formed through the pressure reduction and temperature reduction in the throttling device can be circularly evaporated by the second evaporator 6 to form a gaseous refrigerant, during which a large amount of heat is absorbed, thereby cooling the cool storage material 16. In order to ensure that the power device 9 can smoothly transport the cool storage material 16 to the third evaporator 8 to achieve the optical cool storage effect, when the cool storage material 16 is partially condensed to form a solid-liquid mixture, the refrigerant is no longer evaporated through the second evaporator 6 to cool the cool storage material 16, and the compressor 1 can stop working to stop the temperature reduction, or a control valve can be provided outside the inlet 61 of the second evaporator 6, and the temperature reduction can be stopped by switching off the control valve. When the cool storage material 16 is water, the water may be partially frozen to form an ice-water mixture. The low-pressure gaseous refrigerant generated after the refrigerant is circularly evaporated by the second evaporator 6 and is sent back to the compressor 1 for recompression, to form a high-temperature and high-pressure gaseous refrigerant, thereby realizing a cooling cycle.

The second fan 10 is arranged on one side of the first evaporator 5 and the third evaporator 8. The second fan 10 can blow the first evaporator 5 and the third evaporator 8 to speed up the evaporation. When the first evaporator 5 and/or the second evaporator 6 are working, the second fan 10 is provided for blowing out the cold air formed around the first evaporator 5 and/or the second evaporator 6.

When the first solenoid valve 11 is switched on, the first evaporator 5 is communicatively connected to the condenser 2. In this way, the low-temperature and low-pressure liquid refrigerant after pressure reduction and temperature reduction by the throttling device 4 can be circularly evaporated by the first evaporator 5, so that the liquid refrigerant becomes a low-pressure gaseous refrigerant and absorbs a large amount of heat. Thus, the air around the first evaporator 5 forms a cold air, and the second fan 10 can blow out the cold air around the first evaporator 5 to achieve indoor cooling. The low-pressure gaseous refrigerant generated after the circular evaporation by the first evaporator 5 is sent back to the compressor 1 and is recompressed into a high-temperature and high-pressure gaseous refrigerant, thereby realizing a cooling cycle. When the first solenoid valve 11 is switched off, the first evaporator 5 are not communicated to the condenser 2, and the first evaporator 5 does not work at this time.

When the regenerator 7 is in a low temperature state, the power device 9 can send the cool storage material 16 to the third evaporator 8 for evaporation and heat absorption. The cool storage material 16 absorbs heat, so that the air around the third evaporator 8 forms a cold air, and the second fan 10 can blow out the air around the third evaporator 8, so as to achieve indoor cooling. The cool storage material 16 can be sent back to the regenerator 7 after heat exchange by the third evaporator 8, thereby realizing a cooling cycle. In the cooling process, when the compressor 1 stops working, the temperature of the cool storage material 16 continues to rise.

In some embodiments, the housing 100 may be configured as an integral structure, or may be composed of several parts. A plurality of wheels can be provided at the bottom of the housing 100 to facilitate the overall movement of the housing 100.

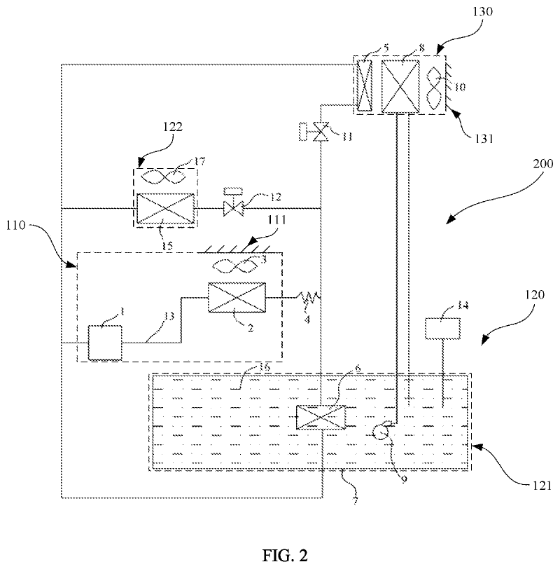

In some embodiments, referring to FIGS. 1-2, the housing 100 includes a first accommodating space 110, a second accommodating space 120, and a third accommodating space 130 that are separately arranged. The compressor 1 and the condenser 2 are arranged in the first accommodating space 110. The second evaporator 6 and the regenerator 7 are arranged in the second accommodating space 120, and the first evaporator 5 and the third evaporator 8 for cooling the indoor environment are arranged in the third accommodating space 130. The first accommodating space 110 is provided with a first wall 111, and the first fan 3 is provided on the first wall 111. The third accommodating space is provided on the second wall 131, and the second fan 10 is provided on the second wall 131. The first wall 111 and the second wall 131 may be arranged on different inner side walls of the housing 100, so that a blowing direction of the first fan 3 is opposite to a blowing direction of the second fan 10.

Since the blowing directions of the first fan 3 and the second fan 10 are opposite, it is convenient to arrange the first fan 3 to blow outdoors and the second fan 10 to blow indoors. Further, a heat exhaust port that can be opened and closed can be arranged in the indoor environment in advance. When the cool storage material 16 is provided for cooling, the heat exhaust port can be hermetically sealed to achieve a good cooling effect. When the first evaporator 5 performs cooling, the heat exhaust port can be opened, and the blowing direction of the first fan 3 is directed toward the heat exhaust port to exhaust heat. The air outlet of the first fan 3 can be arranged in a tube shape, and the heat exhaust port can also be arranged in a tube shape. When the heat is required to be exhausted, the air outlet of the first fan 3 can be directly connected to the heat exhaust port to achieve heat exhaust. On the one hand, it can facilitate quick docking. On the other hand, it can achieve a good sealing effect, preventing hot air from flowing back into the indoor environment and affecting the cooling effect.

Specifically, the housing 100 is divided into a plurality of independent spaces, such as the first accommodating space 110, the second accommodating space 120, and the third accommodating space 130 in the embodiment, so that the conduction of the heat in each independent space can be better controlled, thereby improving the cooling efficiency of the portable air conditioner.

As shown in FIG. 1, in some embodiments, the second accommodating space 120 includes a first chamber 121 and at least one second chamber 122 that are separately arranged. The second evaporator 6 and the regenerator 7 are arranged in the first chamber 121. The cooling system 200 further includes a fourth evaporator 15, and the fourth evaporator 15 is arranged in the second chamber 122. The fourth evaporator 15 is connected to the throttling device 4, and is also connected to the air inlet 300 of the compressor 1. A plurality of second chambers 122 may be provided, and each second chamber 122 is correspondingly provided with a fourth evaporator 15. Each fourth evaporator 15 is provided for circular evaporating to achieve cooling. The evaporator is adopted to circularly evaporate to achieve cooling in the fourth evaporator 15, so that the air around the fourth evaporator 15 forms the cold air, thereby forming a cooling area in the second chamber 122 form. A third fan 17 is provided on one side of the fourth evaporator 15, which can blow out the cold air around the fourth evaporator 15, so that the second chamber 122 can quickly form a cooling area. According to actual requirements, the second chamber 122 can be designed as a refrigerator or a cold drink area. A second solenoid valve 12 may be provided between the fourth evaporator 15 and the condenser 2 to control whether the fourth evaporator 15 is cooled by switching on or switching off the second solenoid valve 12.

In some embodiments, the cooling system 200 further includes a first temperature detection device 14 for detecting the temperature of the cool storage material 16, and the first temperature detection device 14 may be communicatively connected to the first solenoid valve 11. The first temperature detection device 14 may be a temperature controller, which may convert the measured temperature signal of the cool storage material 16 into an electrical signal through a temperature detection device such as a thermocouple or a platinum resistor, and then the first solenoid valve 11 or other parts are controlled by a single-chip microcomputer or a programmable logic controller (PLC) according to the above-mentioned electrical signals, so that the first solenoid valve 11 or other parts can achieve a predetermined action.

The first temperature detection device 14 can select whether to turn on the first solenoid valve 11 according to the temperature of the cool storage material 16, thereby improving the cooling effect or saving energy. For example, when the temperature of the cool storage material 16 rises to a certain temperature, such as 15° C., the first temperature detection device 14 can send a signal to turn on the first solenoid valve 11, and the first evaporator 5 starts to work for rapid cooling. When the temperature of the cool storage material 16 drops to a certain temperature, such as 5° C., the first temperature detection device 14 can send a signal to turn off the first solenoid valve 11 and the second evaporator 6 stops working.

In some embodiments, the first temperature detection device 14 may be communicatively connected to the compressor 1. When the temperature of the cool storage material 16 drops to a freezing point, in order to prevent the cool storage material 16 from being completely condensed, the first temperature detection device 14 may send a signal to make the compressor 1 stop working, thereby stopping cooling.

In some embodiments, the cooling system 200 further includes a second temperature detection device 18 for detecting indoor temperature, and the second temperature detection device 18 may be communicatively connected to the power device 9. The second temperature detection device 18 may also be a temperature controller. When the indoor temperature reaches a certain temperature, such as 30° C., the second temperature detection device 18 can send a signal to start the power device 9 and then the third evaporator 8 performs cooling.

In some embodiments, the second temperature detection device 18 may be communicatively connected to the first solenoid valve 11. When the indoor temperature reaches a certain temperature, such as 35° C., the second temperature detection device 18 can send a signal to open the first solenoid valve 11, and then the first evaporator 5 performs rapid cooling.

In some embodiments, the cooling system 200 may also include a timing module. The timing module may communicate with the power device 9, the first solenoid valve 11, or the compressor 1. When the preset time is reached, the timing module sends a signal to stop or start the cooling of the portable air conditioner.

A preferred embodiment of the present disclosure provides a cooling method of the portable air conditioner, including the following steps.

S1) The cool storage material 16 is placed in the regenerator 7 in advance.

S2) The first solenoid valve 11 is switched off.

S3) A first refrigerant is circularly evaporated in the second evaporator 6 to cool the cool storage material 16.

S4) According to a temperature of the cool storage material 16 or an indoor temperature, the cooling is performed by mode 1, mode 2 or mode 3. The three cooling modes are respectively performed as follows.

Mode 1) The first solenoid valve 11 is kept off, and the power device 9 is turned on, so that the cool storage material 16 is circularly evaporated in the third evaporator 8 to cool the indoor environment.

Mode 2) The first solenoid valve 11 is kept on, and the power device 9 is turned off, so that the refrigerant is circularly evaporated in the first evaporator 5 to cool the indoor environment.

Mode 3) The first solenoid valve 11 is kept on, and the power device 9 is turned on, so that the cool storage material 16 is circularly evaporated in the third evaporator 8, and the refrigerant is circularly evaporated in the first evaporator 5 at the same time, to cool the indoor environment.

In a conclusion, according to the temperature of the cool storage material 16 or the indoor temperature, three cooling modes can be used for cooling. In this way, an appropriate cooling mode can be selected according to the actual requirements. When the cool storage material and the refrigerant are together used for cooling, the portable air conditioner has an enhanced cooling performance together with a desirable dehumidification effect.

Described above are only preferred embodiments of the present disclosure, which are not intended to limit the scope of the present disclosure. It should be understood that modifications, changes and replacements made by those skilled in the art without departing from the spirit of the disclosure shall fall within the scope of the disclosure defined by the appended claims.

What is claimed is:

1. A portable air conditioner, comprising:
a housing; and
a cooling system arranged in the housing;
wherein the cooling system comprises:
a compressor;
a condenser;
a first fan;
a throttling device;
a first evaporator;
a second evaporator;
a regenerator;
a third evaporator;
a power device; and
a second fan;
wherein the compressor comprises an air inlet and an air outlet, and the air outlet is provided with a heat dissipation material; the condenser is connected to the air outlet of the compressor through a delivery pipe; the first fan is arranged on one side of the condenser and the compressor; the throttling device is connected to the condenser; the first evaporator is connected to the throttling device, and is connected to the air inlet of the compressor; a first solenoid valve is connected between the first evaporator and the condenser; the second evaporator is connected to the throttling device, and also connected to the air inlet of the compressor; the regenerator is provided with a storage chamber; a cool storage material is provided in the storage chamber; the second evaporator is arranged in the storage chamber and is in contact with the cool storage material; the third evaporator is arranged on one side of the first evaporator; the power device is communicatively connected to the storage chamber; the third evaporator is communicatively connected to the power device, and is also communicatively connected to the storage chamber; and arranged on one side of the first evaporator and the third evaporator.

2. The portable air conditioner of claim 1, wherein the regenerator is an insulated cabinet.

3. The portable air conditioner of claim 1, wherein the cooling system further comprises a first temperature detection device for detecting a temperature of the cool storage material, and the temperature detection device is communicatively connected to the first solenoid valve.

4. The portable air conditioner of claim 3, wherein the temperature detection device is communicatively connected to the compressor.

5. The portable air conditioner of claim 1, wherein the cooling system further comprises a second temperature detection device for detecting an indoor temperature, and the indoor temperature detection device is communicatively connected to the power device.

6. The portable air conditioner of claim 5, wherein the second temperature detection device is communicatively connected to the first solenoid valve.

7. The portable air conditioner of claim 1, wherein the housing comprises a first accommodating space, a second accommodating space, and a third accommodating space that are separately arranged; the compressor and the condenser are arranged in the first accommodating space; the second evaporator and the regenerator are arranged in the second accommodating space; the first evaporator and the third evaporator are arranged in the third accommodating space; the first accommodating space is provided with a first wall; the third accommodating space is provided with a second wall; the first fan is arranged on the first wall; the second fan is arranged on the second wall; the first wall and the second wall are respectively provided on different inner side walls of the housing, so that a blowing direction of the first fan is opposite to a blowing direction of the second fan.

8. The portable air conditioner of claim 7, wherein the second accommodating space comprises a first chamber and at least one second chamber that are separately arranged; the second evaporator and the regenerator are arranged in the first chamber; the cooling system further comprises a fourth chamber; the fourth evaporator is arranged in the second chamber; the fourth evaporator is connected to the throttling device and the air inlet of the compressor.

9. The portable air conditioner of claim 7, wherein the heat dissipation material is aluminum substrate.

10. A cooling method using the portable air conditioner of claim 1, comprising:
S1) placing the cool storage material in the regenerator in advance;
S2) switching on the first solenoid valve;
S3) circulating a refrigerant in the second evaporator to cool the cool storage material; and
S4) according to a temperature of the cool storage material or an indoor temperature, performing a cooling by one of mode 1, mode 2 or mode 3; wherein the mode 1 is performed through steps of:
keeping the first solenoid valve off; turning on the power device; and circularly evaporating the cool storage material in the third evaporator to cool an indoor environment;
the mode 2 is performed through steps of:
keeping the first solenoid valve on; turning off the power device; and circularly evaporating a second refrigerant in the first evaporator to cool the indoor environment; and
the mode 3 is performed through steps of:
switching on the first solenoid valve; turning on the power device; and circularly evaporating the cool storage material in the third evaporator, and circularly evaporating the second refrigerant in the first evaporator at the same time to cool the indoor environment.
